(19) United States
(12) Patent Application Publication
(10) Pub. No.: US 2026/0368684 A1
(43) Pub. Date: Nov. 19, 2026

(54) LOGISTICS INFORMATION DETECTION METHOD AND SYSTEM, ELECTRONIC DEVICE, AND STORAGE MEDIUM

(71) Applicant: SF TECHNOLOGY CO., LTD., Shenzhen (CN)

(72) Inventor: Xiaoping YANG, Shenzhen (CN)

(73) Assignee: SF TECHNOLOGY CO., LTD., Shenzhen (CN)

(21) Appl. No.: 19/725,458

(22) Filed: Jun. 30, 2026

Related U.S. Application Data
(63) Continuation of application No. PCT/CN2024/143742, filed on Dec. 30, 2024.

(30) Foreign Application Priority Data
Dec. 30, 2023 (CN) 202311871263.5

(51) Int. Cl. G06Q 10/083; G06T 7/00; G06T 7/90

(52) U.S. Cl. CPC G06Q 10/083; G06T 7/0008; G06T 7/90; G06T 2207/10116

(57) ABSTRACT

The present application provides a logistics information detection method and system, an electronic device, and a storage medium. The method includes: receiving at least one set of transit information of a target parcel, where any set of transit information includes a radiographic image, weighing data, and order information of the target parcel at a corresponding transit node; determining, based on at least one of the weighing data and the order information in the at least one set of transit information and the radiographic image, a target transit node corresponding to the target parcel entering a preset lost state, where the preset lost state is used to represent a state in which the target parcel is lost; and outputting order information of the target transit node and information of the target transit node.

### CROSS-REFERENCE TO RELATED APPLICATIONS

This application is a continuation of International Application No. PCT/CN2024/143742, filed on Dec. 30, 2024, which claims priority to Chinese Patent Application No. 202311871263.5, filed on Dec. 30, 2023. The disclosures of the aforementioned applications are hereby incorporated by reference in their entireties.

### TECHNICAL FIELD

The present application relates to the technical field of logistics, and in particular, to a logistics information detection method and system, an electronic device, and a storage medium.

### BACKGROUND

Logistics is a process of moving items from a supply place to a receiving place, including a series of activities such as transportation, storage, packaging, distribution, loading and unloading, custody, and logistics information management of the items. During the movement of the items, loss of the items occurs occasionally. At present, lost item parcels are detected manually. However, with respect to thousands of item parcels and a plurality of transportation links, not only the labor cost is high, but also the detection efficiency is low.

### SUMMARY

The present application provides a logistics information detection method and system, an electronic device, and a storage medium, which can automatically screen parcels suspected of being lost from a large number of parcels, thereby not only saving the labor cost, but also improving the detection efficiency.

In a first aspect, an embodiment of the present application provides a logistics information detection method, including: receiving at least one set of transit information of a target parcel, where any set of transit information includes a radiographic image, weighing data, and order information of the target parcel at a corresponding transit node; determining, based on at least one of the weighing data and the order information in the at least one set of transit information and the radiographic image, a target transit node corresponding to the target parcel entering a preset lost state, where the preset lost state is used to represent a state in which the target parcel is lost; and outputting order information of the target transit node and information of the target transit node.

In a second aspect, an embodiment of the present application provides a logistics information detection system, including: a receiving module, configured to receive at least one set of transit information of a target parcel, where any set of transit information includes a radiographic image, weighing data, and order information of the target parcel at a corresponding transit node; a determining module, configured to determine, based on at least one of the weighing data and the order information in the at least one set of transit information and the radiographic image, a target transit node corresponding to the target parcel entering a preset lost state, where the preset lost state is used to represent a state in which the target parcel is lost; and an output module, configured to output order information of the target transit node and information of the target transit node.

In a third aspect, an embodiment of the present application provides an electronic device, including a memory, a processor, and a computer program stored in the memory and capable of being run in the processor, where the processor runs the computer program to implement the method of the first aspect.

In a fourth aspect, an embodiment of the present application provides a computer-readable storage medium, having a computer program stored therein, where the computer program is executed by a processor to implement the method of the first aspect.

In the embodiments of the present application, the transit information such as the radiographic images, the weighing data, and the order information of the target parcel at each transit node is received. Based on processing of the at least one set of transit information, it is possible to detect whether the target parcel is suspected of being lost and a transit link at which the loss is suspected, and output relevant detection results to facilitate further confirmation of a loss case. In this way, not only most of the transit data can be filtered out in an automated mode, greatly improving the detection efficiency, but also the timely solving of the problem of item loss is facilitated before a user perceives the loss, thereby improving user experience.

### BRIEF DESCRIPTION OF DRAWINGS

FIG. 1 shows a schematic architectural diagram of a logistics system provided in an embodiment of the present application.

FIG. 2 shows a method flowchart of a logistics information detection method provided in an embodiment of the present application.

FIG. 3 shows a schematic architectural diagram of a logistics information detection system provided in an embodiment of the present application.

FIG. 4 shows a schematic composition diagram of a logistics information detection system provided in an embodiment of the present application.

FIG. 5 shows a schematic structural diagram of an electronic device provided in an embodiment of the present application.

FIG. 6 shows a schematic structural diagram of a storage medium provided in an embodiment of the present application.

### DESCRIPTION OF EMBODIMENTS

First, a technical scenario involved in the embodiments of the present application is described.

In the logistics field, items are usually packaged into parcels for movement. During the movement of a parcel, the parcel undergoes at least one transit. In an actual implementation scenario, a large number of parcels usually undergo multiple transits, respectively. In the scenario where a large number of parcels undergo multiple transits, loss or replacement of items inside parcels often occurs, thereby resulting in poor user experience.

The existing way to detect lost items is usually as follows: after receiving information about lost of an item fed back by a user, a movement route, the number of transit times, relevant data at each transit, and the like of an item parcel is manually traced to identify a transit node where the item is suspected of being lost, then further detection and verification are performed, and a conclusion and a solution are provided. Since the parcel to be detected may have undergo multiple transits, and each transit may involve processing together with a large number of other parcels, the manual detection method not only has high labor cost, but also requires processing a large amount of data, resulting in low detection efficiency and further reducing user experience.

In view of this, an embodiment of the present application provides a logistics information detection system. The logistics information detection system may identify a parcel suspected of being lost and the transportation link where the parcel is suspected of being lost by detecting parcel information (also referred to as transit information) acquired at each transit node, and then output relevant identification results to facilitate further confirmation of the loss case. In this way, not only most of the data can be filtered out in an automated mode, greatly improving the detection efficiency, but also the timely solving of the problem of item loss is facilitated before a user perceives the loss, thereby improving user experience.

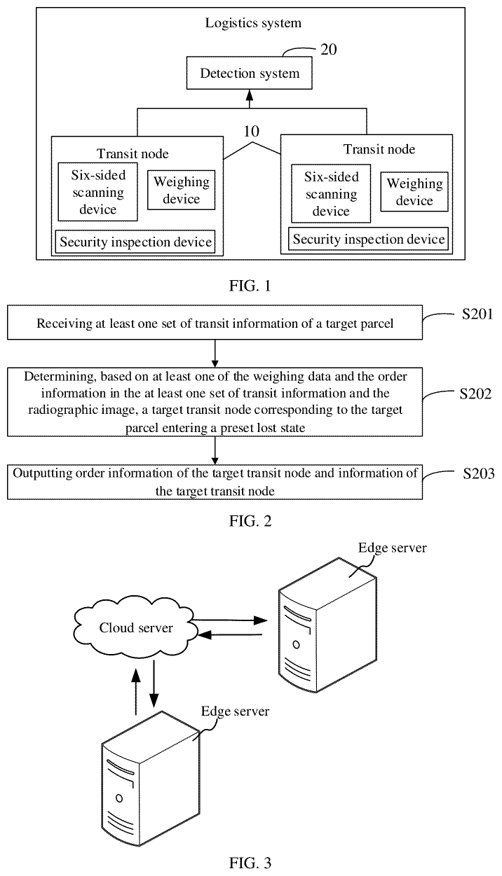

As shown in FIG. 1, the logistics system involved in the embodiments of the present application may include: at least one transit node 10 and a detection system 20, and relevant devices of the at least one transit node 10 are all in communication connection to the detection system 20.

It should be understood that a technical scenario shown in FIG. 1 is only one technical scenario of a solution of the present application, and does not limit the technical scenario of the solution of the present application. The transit nodes 10 and the detection system 20 shown in FIG. 1 may be considered as logically equivalent functional components. In an exemplary embodiment, in the technical scenario of the solution of the present application, each transit node 10 may include a plurality of parcel inspection devices, and the detection system 20 may also include a plurality of detection devices. As shown in FIG. 3, the plurality of detection devices of the detection system 20 include a cloud server and a plurality of edge servers. No limitation is imposed herein.

Any transit node 10 may correspond to a logistics transit yard in an actual logistics scenario. Correspondingly, a plurality of parcel inspection devices of any transit node 10 may include a six-sided scanning device, a weighing device, and a security inspection device, so as to use the six-sided scanning device to perform six-sided scanning on a parcel passing through the transit node 10 to acquire order information of the parcel, use the weighing device to weigh the parcel to acquire weighing data of the parcel at the transit node, and use the security inspection device to scan the parcel to acquire a radiographic image of the parcel. The parcel information acquired by the three devices of the transit node 10 may serve as the transit information of the transit node 10. Thereafter, the three devices of the transit node 10 may transmit the acquired parcel information to the detection system 20, respectively, so that the detection system 20 detects the transit information of the parcel at the transit node 10 to determine whether the state of the parcel at the transit node 10 is a preset lost state.

In an exemplary embodiment, the six-sided scanning device, the weighing device, and the security inspection device of any transit node 10 may be arranged in order, for example, after the parcel enters the transit node 10, the parcel may first pass through the six-sided scanning device, then the weighing device, and finally the security inspection device. The three devices of any transit node 10 may transmit the acquired parcel information to the detection system 20 after acquiring parcel information of a parcel.

It should be noted that different parcels may pass through different numbers of transit nodes 10 depending on logistics addresses and paths. For example, some parcels with relatively short logistics paths (e.g., between adjacent cities) may pass through one transit node 10; and for another example, some parcels with relatively long logistics paths (e.g., across a plurality of cities) may pass through a plurality of transit nodes 10. If an item in a parcel is lost during transportation, at least one of the radiographic image and the weighing data of the parcel will change. Based on this, after acquiring parcel information at each transit node 10, the parcel information is transmitted to the detection system 20, which is conducive for the detection system 20 to screen the parcel suspected of having lost an item by detecting the transit information of each transit node 10.

After receiving a set of transit information at any transit node 10, the detection system 20 may establish a correspondence among the radiographic image, the weighing data, and the order information in the set of transit information, and detect the radiographic image, the weighing data, and the order information according to a preset detection rule. The detection of the radiographic image by the detection system 20 may be implemented as identifying the state of the corresponding radiographic image based on image features of the radiographic image, or detecting the similarity of the image features of the same parcel at two transit nodes 10 to identify the state of the item in the corresponding parcel, etc. In the embodiments of the present application, the image features of the radiographic image may be implemented as different features in different implementations. The detection of the weighing data by the detection system 20 may be implemented as: comparing the consistency of the weighing data of the same parcel at two adjacent transit nodes, so as to assist in identifying whether the item of the parcel is lost. The detection of the order information by the detection system 20 may include determining item information in the parcel or attribute information of the parcel through the order information.

Correspondingly, functional modules such as an image recognition algorithm or a network model, a data comparison module, and an information recognition module may be pre-deployed in the detection system 20. A plurality of image recognition algorithms or network models may be included according to implementation scenarios, for example, including a lightweight convolutional neural network (MobileNet) and a siamese network.

The detection system 20 may be implemented as any electronic device that supports the above detection functions. The electronic device may be an independent server, or may be a server network, a server cluster, a blockchain system, or the like composed of servers. The electronic device described in the embodiments of the present application may include, but not limited to, a computer, a network host, a single network server, a set of a plurality of network servers, a cloud server composed of a plurality of servers, or a combination form of an edge server and a cloud server, etc. The cloud server is composed of a large number of computers or network servers based on cloud computing.

In an exemplary embodiment, when the detection system 20 includes a first detection device and a second detection device, different functional modules may be deployed in different detection devices according to the computing power of the first detection device and the second detection device, so that the first detection device and the second detection device perform different steps in the detection method (as illustrated in the embodiment of FIG. 2).

The logistics information detection method and system, the device, and the storage medium of the embodiments of the present application are described below in conjunction with examples.

FIG. 2 shows a logistics information detection method provided in an embodiment of the present application. The logistics information detection method illustrated in FIG. 2 may be applied to the detection system 20 illustrated in FIG. 1, for example, the method is executed by the cloud server and/or the edge server in FIG. 3. The logistics information detection method described in the embodiments of the present application may include the following steps.

In step S201, at least one set of transit information of a target parcel is received.

The target parcel may be any transited parcel.

It should be understood that although a parcel may pass through a plurality of transit nodes, and a transit node processes a plurality of parcels, the detection process of the transit information of any parcel at each transit node may be considered the same. Based on this, the embodiments of the present application take any transited parcel as the target parcel to describe the embodiments of the logistics information detection method of the present application.

In conjunction with the above technical scenario, any set of transit information includes a radiographic image, weighing data, and order information of the target parcel at a corresponding transit node.

In an exemplary embodiment, the order information may be implemented in the form of a barcode or a two-dimensional code. The barcode or two-dimensional code may be obtained by converting an order number, an item name, or remark information (e.g., the number of items, fragility status, and insurance status) of the target parcel.

In conjunction with the embodiment illustrated in FIG. 1, the radiographic image, the weighing data, and the order information in any set of transit information of the target parcel are acquired by three devices of the corresponding transit node, respectively. Correspondingly, the detection system may receive the corresponding information from three devices of the corresponding transit node. In order to facilitate the management and detection of the parcel information of the corresponding transit node, after receiving the radiographic image, the weighing data, and the order information of the target parcel, the detection system may, for example, use the order information as an index to establish a correspondence among the three pieces of information.

In an exemplary embodiment, in a case that the detection system includes a first detection device and a second detection device, both the first detection device and the second detection device may receive at least one set of transit information of the target parcel. If the computing power of the first detection device is different from the computing power of the second detection device, for example, the computing power of the first detection device is less than the computing power of the second detection device, the first detection device may receive the radiographic image and the order information in the at least one set of transit information of the target parcel, while the second detection device may receive, in a case that the target parcel corresponds to at least two sets of transit information, the radiographic images, the weighing data, and the order information in the at least two sets of transit information of the target parcel, and establish the correspondence among the three pieces of parcel information in each set of transit information.

Exemplarily, in a case that the computing power of the first detection device is less than the computing power of the second detection device, the first detection device may first receive the radiographic image and the order information in at least one set of transit information of the target parcel, and when it is determined that the target parcel corresponds to at least two sets of transit information, the first detection device may transmit a command to each connected transit node, so that each transit node transmits all the transit information of the target parcel to the second detection device.

In step S202, based on at least one of the weighing data and the order information in the at least one set of transit information and the radiographic image, a target transit node corresponding to the target parcel entering a preset lost state is determined.

If the transit information meets a preset condition, it may be determined that the transit information represents that the target parcel is in the preset lost state. The preset lost state is used to represent a state in which the target parcel is lost.

It should be pointed out that there may be various loss scenarios of items in the target parcel may, for example, all items in the target parcel are lost; for another example, a part of the items in the target parcel are lost; and for yet another example, the items in the target parcel are replaced, etc. For different loss scenarios, the changed parcel information is also different. For example, if the items in the target parcel are completely lost, the radiographic image of the target parcel shows that there is no item in the target parcel, and the weighing data of the target parcel will decrease; for another example, if a part of the items in the target parcel are lost, the radiographic image of the target parcel still shows that there are items in the target parcel, however, the weighing data of the target parcel will still decrease; and for another example, if the items in the target parcel are replaced, the radiographic image of the target parcel still shows that there are items in the target parcel, and the weighing data of the target parcel may change to some extent, however, the contents of the radiographic images corresponding to different transit information of the target parcel will change.

It should be understood that the above only lists illustrative item loss scenarios and the changes in parcel information caused by different loss scenarios, and do not limit the scenarios involved in the embodiments of the present application. In actual implementation scenarios, there may be more the item loss scenarios than those listed above, and the corresponding changes in parcel information under different loss scenarios may be more complex and variable. No further enumeration is provided here.

With reference to the changes in parcel information caused by the different loss scenarios above, the conditions for the transit information to represent that the target parcel is in the preset lost state may include, for example: there is no item in the target parcel, there is no item in the target parcel and the weighing data of two adjacent sets of transit information of the target parcel are different, the weighing data and the contents of the radiographic images of two adjacent sets of transit information of the target parcel are both different, etc. Further, in the embodiments of the present application, based on at least one of the weighing data and the order information and the radiographic image, it may detect, according to different loss scenarios, whether the target parcel is in the preset lost state at the relevant transit node from different perspectives.

It should be understood that detecting whether the target parcel is in the preset lost state at the relevant transit node from different perspectives may be understood as that there are multiple ways to detect whether the target parcel is in the preset lost state at the relevant transit node, and different ways correspond to different perspectives. These ways may be flexibly combined according to different needs, that is, these ways are not mutually exclusive.

In some embodiments for detecting whether the target parcel is in the preset lost state at the relevant transit node, for any set of transit information, in response to receiving the transit information, the detection system may detect, based on the order information and the radiographic image in the transit information, whether the transit information represents that the target parcel is in the preset lost state. If the transit information represents that the target parcel is in the preset lost state, the detection system may determine the transit node corresponding to the transit information as the target transit node.

Exemplarily, the detection system may determine an item state of the target parcel according to the radiographic image in the transit information. In a case that it is determined that there is no item in the target parcel, that is, in a case that the target parcel is an empty parcel, the detection system may determine whether the item type indicated by the order information in the transit information is a preset type. In a case that the item type indicated by the order information is the preset type, it is determined that the transit information represents that the target parcel is in the preset lost state.

The radiographic image may represent the items in the target parcel through colors or brightness of colors, etc. For example, for items that cannot be penetrated by the light of a security inspection machine, the radiographic image thereof may be a blue image with a certain contour, while for items that can be penetrated by the light of the security inspection machine, the radiographic image thereof may be an orange image with relatively low brightness. Based on this, the detection system may extract a color feature of the radiographic image, the color feature including a brightness feature value of the radiographic image. For example, if the brightness feature value is greater than a preset brightness threshold, it is determined that there is no item in the target parcel.

Exemplarily, the brightness feature value may be flexibly set according to needs, for example, the brightness feature value may be set to 128. The brightness feature value is used to represent the brightness value of the radiographic image.

The detection system may, for example, invoke a pre-trained MobileNet to extract the color feature of the radiographic image, and the color feature may include features of each color among red, green, and blue (Red Green Blue, RGB) primary colors of the radiographic image, as well as brightness features or transparency features of the colors. Furthermore, the MobileNet may determine, based on the extracted color feature, the type of the item state in the parcel matched by the radiographic image. The types of the item state in the parcel may include, for example, no item (i.e., an empty parcel), or having items but the parcel is not full, or the parcel being full. The item state is used to represent whether an item is present in the target parcel and whether the target parcel is fully filled with the item if the item is present.

It should be pointed out that, in actual implementation scenarios, the color features of the radiographic images of some items may be similar to those of an empty parcel, such as clothes or paper. Based on this, it may not be accurate to determine that the target parcel is in a lost state by determining that there is no item in the target parcel through the color features of the radiographic image. In order to improve the accuracy of the detection result, after determining that there is no item in the target parcel according to the color features of the radiographic image, the state of the target parcel may be further detected according to at least one of the order information and the weighing data of the target parcel.

In actual implementation scenarios, types of some items may be preset according to empirical values with a relatively high loss rate, as a basis for further determining whether an empty parcel is a parcel in the lost state. Furthermore, after determining that there is no item in the target parcel, it may be determined, according to the order information of the target parcel, whether the item in the target parcel is a preset type of item. If the item in the target parcel is the preset type of item, it may be determined that the target parcel is the parcel in the lost state. The preset type may include, for example, a type having an item name that indicates an electronic product, and a type for which a user has chosen to insure the item.

In addition, in a case that it is determined that there is no item in the target parcel and the item in the target parcel is not the preset type of item, and in a case that the target parcel corresponds to at least two sets of transit information, it may be determined, by comparing the weighing data in every two adjacent sets of transit information, whether the weight of the target parcel is changed during the transit process. If the weight of the target parcel is changed during the transit process, it may be determined that the target parcel is changed to be in the preset lost state.

Exemplarily, in a case that the item type indicated by the order information is not the preset type, the detection system may, starting from the transit information, sequentially compare the weighing data in every two adjacent sets of transit information among the earlier transit information acquired earlier than the transit information. The weighing data in the transit information acquired later (later in time) among any two adjacent sets of transit information is taken as first weighing data, and the weighing data in the transit information acquired earlier (earlier in time) among two adjacent sets of transit information is taken as second weighing data. In a case that a first weight indicated by the first weighing data is less than a second weight indicated by the second weighing data, it may be determined that during the transportation between the transit nodes corresponding to the two adjacent sets of transit information, and the item in the target parcel is lost. Correspondingly, it may be determined that the transit information corresponding to the first weighing data represents that the target parcel is changed to be in the preset lost state.

The above implementation is directed to detection of a scenario in which all items in the target parcel are lost. For a scenario in which a part of the items in the target parcel are lost or replaced, the embodiments of the present application may perform detection by comparing the radiographic images and the weighing data in two adjacent sets of transit information.

In some other embodiments for detecting whether the target parcel is in the preset lost state at the relevant transit node, in a case that the at least one set of transit information includes at least two sets of transit information, the detection system may detect, based on the weighing data and the radiographic images in the at least two sets of transit information, whether the target parcel is changed to be in the preset lost state. In a case that the target parcel is changed to be in the preset lost state, the transit node corresponding to the transit information after a state change of the target parcel is determined as the target transit node.

Exemplarily, in response to receiving an i-th set of transit information, the detection system may compare i-th weighing data with (i-1)-th weighing data, where the i-th weighing data refers to the weighing data in the i-th set of transit information, the (i-1)-th weighing data refers to the weighing data in the (i-1)-th set of transit information, and i is an integer greater than or equal to 2, i.e., the (i-1)-th set of transit information and the i-th set of transit information are transit information of any two adjacent transit nodes. In a case that an i-th weight indicated by the i-th weighing data is less than an (i-1)-th weight indicated by the (i-1)-th weighing data, it is detected whether an i-th radiographic image is the same as an (i-1)-th radiographic image. The i-th radiographic image refers to the radiographic image in the i-th set of transit information, and the (i-1)-th radiographic image refers to the radiographic image in the (i-1)-th set of transit information. In a case that the i-th radiographic image is different from the (i-1)-th radiographic image, it indicates that, in the two sets of transit information of the target parcel, both the weight and the contents of the items are different. Then, it may be determined that during the transportation between the adjacent transit nodes, a part of the items in the target parcel are lost, and it may be determined that the target parcel is changed to be in the preset lost state at the transit node corresponding to the i-th set of transit information.

It should be pointed out that, in this example, detecting whether the i-th radiographic image is the same as the (i-1)-th radiographic image refers to detecting whether the image content in the i-th radiographic image is the same as the image content in the (i-1)-th radiographic image. Based on this, in this example, the detection system may respectively extract semantic features of the i-th radiographic image and semantic features of the (i-1)-th radiographic image to obtain a first semantic feature and a second semantic feature, and then calculate a similarity parameter between the first semantic feature and the second semantic feature. If the similarity represented by the similarity parameter does not satisfy a preset similarity condition, it is determined that the i-th radiographic image is different from the (i-1)-th radiographic image.

The detection system may, for example, invoke a pre-deployed Siamese Network to extract the obtained first semantic feature and the obtained second semantic feature. The similarity parameter between the first semantic feature and the second semantic feature may be, for example, implemented as a Euclidean distance or a cosine distance or other parameters used to represent feature similarity.

It should be understood that the above are only illustrative implementations of item loss detection and do not limit the technical solutions of the embodiments of the present application. In actual implementation scenarios, the neural networks used above for extracting the color features and the semantic features may also be other algorithmic networks that support the relevant functions. No limitation is imposed herein.

In addition, in a scenario where the detection system includes a first detection device and a second detection device, MobileNet may be, for example, pre-configured in the first detection device, and a Siamese Network may be, for example, pre-configured in the second detection device. The first detection device may, for example, perform empty parcel detection and detect whether the item type is a preset type, while the second detection device may, for example, detect whether the weighing data and the contents of the radiographic images are consistent in the transit information of any two adjacent transit nodes.

In an exemplary embodiment, in a case that it is determined that the item in the target parcel is not the preset type of item, the first detection device may acquire the weighing data in each set of transit information of the target parcel from the second detection device to detect whether the weighing data in every two adjacent sets of transit information is changed. In another exemplary embodiment, in a case that it is determined that the item in the target parcel is not the preset type of item, the first detection device may transmit the order information of the target parcel to the second detection device, so that the second detection device detects whether the weighing data in every two adjacent sets of transit information corresponding to the target parcel is changed, and then determines whether the target parcel is in the preset lost state.

In step S203, order information of the target transit node and information of the target transit node are outputted.

After determining that the item in the target parcel is suspected of being lost and the target transit node corresponding to the suspected loss, the detection system may output the order information of the target transit node corresponding to the target parcel and the information of the target transit node corresponding to the suspected loss, so as to trigger relevant personnel to further verify the state of the target parcel. The information of the target transit node may be, for example, a number of a transit yard corresponding to the target transit node, etc.

Exemplarily, the detection system may output the order information of the target transit node and the information of the target transit node through any device having an information output function or a display function in the first detection device and the second detection device. For example, if the first detection device is implemented as the edge server shown in FIG. 3 and the second detection device is implemented as the cloud server shown in FIG. 3, the cloud server may output the order information of the target transit node and the information of the target transit node.

In the embodiments of the present application, by receiving transit information such as radiographic images, weighing data, and order information of the target parcel at each transit node, based on processing of at least one set of the transit information, it is possible to detect whether the target parcel is suspected of being lost and a transit link at which the loss is suspected, and output relevant detection results to facilitate further confirmation of the loss case. In this way, not only most of the transit data can be filtered out in an automated mode, greatly improving the detection efficiency, but also the timely solving of the problem of item loss is facilitated before a user perceives the loss, thereby improving user experience.

In an exemplary embodiment, taking the first detection device as the edge server and the second detection device as the cloud server as an example, the structure of the detection system may be as shown in FIG. 3. In FIG. 3, each transit node may be configured with an edge server, and the edge servers of each transit node may be in communication connection to the cloud server.

The functions of the edge servers and the cloud server may both refer to the description in the corresponding embodiments above, and details are not repeated here.

It can be seen that by adopting the implementation of the present application, a logistics information detection system is provided. The logistics information detection system can identify the parcel suspected of being lost and the transport link at which the parcel is suspected of being lost by detecting parcel information (also referred to as transit information) acquired at each transit node, and then output relevant identification results to facilitate further confirmation of the loss case. In this way, not only most of the data can be filtered out in an automated mode, greatly improving the detection efficiency, but also the timely solving of the problem of item loss is facilitated before a user perceives the loss, thereby improving user experience.

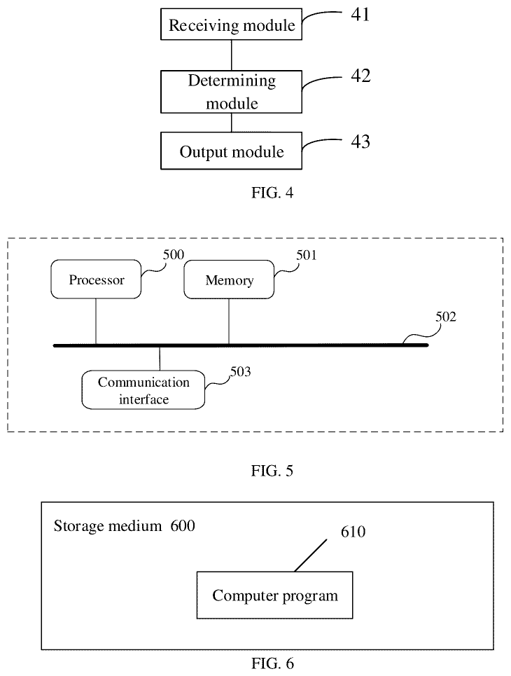

Corresponding to the above implementations of the logistics information detection method, an embodiment of the present application also provides a logistics information detection system. The logistics information detection system may be used as the detection system 20 shown in FIG. 1, for executing the logistics information detection method of any of the above embodiments. It should be understood that the description of the embodiments of the logistics information detection method corresponds to the description of the embodiments of the logistics information detection system, and thus, parts not described in detail may refer to the foregoing method embodiments. As shown in FIG. 4, the logistics information detection system includes: a receiving module 41, a determining module 42, and an output module 43.

The receiving module 41 is configured to receive at least one set of transit information of a target parcel, where any set of transit information includes a radiographic image, weighing data, and order information of the target parcel at a corresponding transit node; the determining module 42 is configured to determine, based on at least one of the weighing data and the order information in the at least one set of transit information and the radiographic image, a target transit node corresponding to the target parcel entering a preset lost state, where the preset lost state is used to represent a state in which the target parcel is lost; and the output module 43 is configured to output order information of the target transit node and information of the target transit node.

In an implementation, the determining module 42 is specifically configured to: for any set of transit information, detect, based on the order information and the radiographic image in the transit information, whether the transit information represents that the target parcel is in the preset lost state; and in a case that the transit information represents that the target parcel is in the preset lost state, determine the transit node corresponding to the transit information as the target transit node.

In an implementation, when detecting, based on the order information and the radiographic image in the transit information, whether the transit information represents that the target parcel is in the preset lost state, the determining module 42 is further configured to: determine an item state of the target parcel according to the radiographic image in the transit information, where the item state is used to represent whether an item is present in the target parcel and whether the target parcel is fully filled with the item if the item is present; and in a case that it is determined that no item is present in the target parcel, determine whether an item type indicated by the order information in the transit information is a preset type, so as to determine whether the transit information represents that the target parcel is in the preset lost state, where in a case that the item type indicated by the order information is the preset type, the transit information represents that the target parcel is in the preset lost state.

In an implementation, when determining the item state of the target parcel according to the radiographic image in the transit information, the determining module 42 is further configured to: extract a color feature of the radiographic image, where the color feature includes a brightness feature value of the radiographic image, and the brightness feature value is used to represent a brightness value of the radiographic image; and determine the item state of the target parcel according to a magnitude relationship between the brightness feature value and a preset brightness threshold, where in a case that the brightness feature value is greater than the preset brightness threshold, no item is present in the target parcel.

In an implementation, in a case that the at least one set of transit information includes at least two sets of transit information, the determining module 42 is specifically configured to: for any set of transit information, detect, based on the order information and the radiographic image in the transit information, whether the target parcel is changed to be in the preset lost state; and in a case that the target parcel is changed to be in the preset lost state, determine the transit node corresponding to the transit information after a state change of the target parcel as the target transit node.

In an implementation, when detecting, based on the order information and the radiographic image in the transit information, whether the target parcel is changed to be in the preset lost state, the determining module 42 is further configured to: determine an item state of the target parcel according to the radiographic image in the transit information, where the item state is used to represent whether an item is present in the target parcel and whether the target parcel is fully filled with the item if the item is present; and in a case that it is determined that no item is present in the target parcel, determine whether an item type indicated by the order information in the transit information is a preset type, so as to determine whether the target parcel is changed to be in the preset lost state.

In an implementation, when determining whether the item type indicated by the order information in the transit information is the preset type, so as to determine whether the target parcel is changed to be in the preset lost state, the determining module 42 is further configured to: in a case that the item type indicated by the order information is not the preset type, starting from the transit information, sequentially compare the weighing data in every two adjacent sets of transit information among the transit information acquired earlier than the transit information, where in the weighing data of every two adjacent sets of transit information, the weighing data in the transit information acquired later in time is first weighing data, and the weighing data in the transit information acquired earlier in time is second weighing data; and determine whether the target parcel is changed to be in the preset lost state according to the first weighing data and the second weighing data, where in a case that a first weight indicated by the first weighing data is less than a second weight indicated by the second weighing data, the target parcel is changed to be in the preset lost state at the transit node corresponding to the transit information acquired later in time, and the transit node corresponding to the transit information acquired later in time is the transit node corresponding to the transit information after a state change of the target parcel.

In an implementation, in a case that the at least one set of transit information includes at least two sets of transit information, the determining module 42 is specifically configured to: detect, based on the weighing data and the radiographic images in the at least two sets of transit information, whether the target parcel is changed to be in the preset lost state; and in a case that the target parcel is changed to be in the preset lost state, determine the transit node corresponding to the transit information after a state change of the target parcel as the target transit node.

In an implementation, when detecting, based on the weighing data and the radiographic images in the at least two sets of transit information, whether the target parcel is changed to be in the preset lost state, the determining module 42 is further configured to: compare i-th weighing data with (i-1)-th weighing data, where the i-th weighing data is the weighing data in an i-th set of transit information among the at least two sets of transit information, the (i-1)-th weighing data is the weighing data in an (i-1)-th set of transit information among the at least two sets of transit information, and the i is an integer greater than or equal to 2; in a case that an i-th weight indicated by the i-th weighing data is less than an (i-1)-th weight indicated by the (i-1)-th weighing data, detect whether an i-th radiographic image is the same as an (i-1)-th radiographic image, where the i-th radiographic image is a radiographic image in the i-th set of transit information, and the (i-1)-th radiographic image is a radiographic image in the (i-1)-th set of transit information; and in a case that the i-th radiographic image is different from the (i-1)-th radiographic image, determine that the target parcel is changed to be in the preset lost state at the transit node corresponding to the i-th set of transit information, where the transit node corresponding to the transit information after a state change of the target parcel is the transit node corresponding to the i-th set of transit information.

In an implementation, when detecting whether the i-th radiographic image is the same as an (i-1)-th radiographic image, the determining module 42 is further configured to: respectively extract a semantic feature of the i-th radiographic image and a semantic feature of the (i-1)-th radiographic image to obtain a first semantic feature and a second semantic feature; calculate a similarity parameter between the first semantic feature and the second semantic feature, where the similarity parameter is used to represent similarity between the first semantic feature and the second semantic feature; and determine whether the i-th radiographic image is the same as the (i-1)-th radiographic image according to the similarity represented by the similarity parameter and a preset similarity condition, where in a case that the similarity represented by the similarity parameter does not satisfy the preset similarity condition, the i-th radiographic image is different from the (i-1)-th radiographic image.

In an implementation, when detecting, based on the weighing data and the radiographic images in the at least two sets of transit information, whether the target parcel is changed to be in the preset lost state, the determining module 42 is further configured to: for any set of transit information, determine an item state of the target parcel according to the radiographic image in the transit information, where the item state is used to represent whether an item is present in the target parcel and whether the target parcel is fully filled with the item if the item is present; in a case that it is determined that no item is present in the target parcel and an item type indicated by the order information in the transit information is not a preset type, starting from the transit information, sequentially compare the weighing data in every two adjacent sets of transit information among the transit information acquired earlier than the transit information, where in the weighing data of every two adjacent sets of transit information, the weighing data in the transit information acquired later in time is first weighing data, and the weighing data in the transit information acquired earlier in time is second weighing data; and determine whether the target parcel is changed to be in the preset lost state according to the first weighing data and the second weighing data, where in a case that a first weight indicated by the first weighing data is less than a second weight indicated by the second weighing data, the target parcel is changed to be in the preset lost state at the transit node corresponding to the transit information acquired later in time, and the transit node corresponding to the transit information acquired later in time is the transit node corresponding to the transit information after a state change of the target parcel.

In an implementation, the detection system includes a first detection device, where the first detection device receives a radiographic image and order information in the at least one set of transit information of the target parcel.

In an implementation, in response to receiving the radiographic image and the order information in the at least one set of transit information, the first detection device detects, based on the order information and the radiographic image in the at least one set of transit information, whether the at least one set of transit information represents that the target parcel is in the preset lost state.

In an implementation, the detection system includes the first detection device and a second detection device, where, in a case that the first detection device receives at least two sets of transit information of the target parcel, the second detection device receives radiographic images, weighing data, and order information in the at least two sets of transit information of the target parcel.

In an implementation, the second detection device detects, based on the weighing data and the radiographic images in the at least two sets of transit information, whether the target parcel is changed to be in the preset lost state.

It should be pointed out that various modules illustrated in FIG. 4 may be understood as software modules for executing different logical functions according to the process for executing the logistics information detection method. This does not conflict with the devices divided according to network deployment in FIG. 3, but rather they are divided from different dimensions.

The logistics information detection system provided in the above embodiments of the present application is based on the same inventive concept as that of the logistics information detection method provided in the embodiments of the present application, and has the same beneficial effects as those of the method adopted, performed, or implemented by an application program stored therein.

In addition, FIG. 4 shows only one embodiment of the logistics information detection system, not all embodiments. Based on the embodiments of the logistics information detection system in the present application, all other embodiments obtained by those skilled in the art without creative efforts shall fall within the protection scope of the present application.

FIG. 4 shows software modules divided from a logical function perspective. In implementation, the functions of the software modules may be integrated into hardware entities for implementation. For example, the functions of the receiving module and the functions of the output module may be integrated into a communication interface for implementation; and the functions of the determining module may be integrated into a processor for implementation, etc.

Based on this, an implementation of the present application further provides an electronic device, which may be used as the detection system 20 shown in FIG. 1, to execute the above logistics information detection method. By referring to FIG. 5, FIG. 5 shows a schematic diagram of an electronic device provided in some implementations of the present application. As shown in FIG. 5, the electronic device includes: a processor 500, a memory 501, a bus 502, and a communication interface 503. The processor 500, the communication interface 503, and the memory 501 are connected through the bus 502. The memory 501 stores a computer program that runs in the processor 500. When running the computer program, the processor 500 executes the logistics information detection method provided in any of the foregoing implementations of the present application.

The memory 501 may include a high-speed random access memory (RAM), and may also include a non-volatile memory (NVM), such as at least one disk memory. The communication connection between the system network element and at least one other network element is implemented through at least one communication interface 503 (which may be wired or wireless), and the Internet, a wide area network, a local network, a metropolitan area network, etc. may be used.

The bus 502 may be an industry standard architecture (ISA) bus, a peripheral component interconnect (PCI) bus, or an extended industry standard architecture (EISA) bus, etc. The bus may be divided into an address bus, a data bus, a control bus, etc. The memory 501 is configured to store a computer program. After receiving an execution instruction, the processor 500 executes the computer program. The logistics information detection method disclosed in any of the implementations illustrated in FIG. 2 may be applied to the processor 500 or implemented by the processor 500.

The processor 500 may be an integrated circuit chip having signal processing capabilities. In the implementation process, the steps of the above method may be completed by an integrated logic circuit of hardware or instructions in the form of software in the processor 500. The above processor 500 may be a general-purpose processor, including a central processing unit (CPU), a network processor (NP), etc., and may also be a digital signal processor (DSP), an application specific integrated circuit (ASIC), a field-programmable gate array (FPGA), or other programmable logic devices, discrete gate or transistor logic devices, or discrete hardware components, which may implement or execute the methods, steps, and logical block diagrams disclosed in the embodiments of the present application. The general-purpose processor may be a microprocessor or the processor may also be any conventional processor, etc. The steps of the method disclosed in conjunction with the embodiments of the present application may be directly embodied as being executed and completed by a hardware decoding processor, or executed and completed by a combination of hardware and software modules in the decoding processor. The software modules may be located in a random access memory, a flash memory, a read-only memory, a programmable read-only memory, or an electrically erasable programmable memory, a register, or other mature storage media in the art. The storage medium is located in the memory 501, and the processor 500 reads information from the memory 501 and completes the steps of the above method in conjunction with the hardware.

The electronic device provided in the embodiments of the present application is based on the same inventive concept as that of the logistics information detection method provided in the embodiments of the present application, and has the same beneficial effects as those of the method adopted, performed, or implemented by the embodiments of the present application.

In addition, FIG. 5 shows only one embodiment of the electronic device, not all embodiments. Based on the embodiment of the electronic device in the present application, all other embodiments obtained by those skilled in the art without creative efforts shall fall within the protection scope of the present application.

Corresponding to the logistics information detection method provided in the foregoing implementations, as shown in FIG. 6, an implementation of the present application further provides a computer-readable storage medium 600 having a computer program 610 (i.e., a program product) stored therein. When running by a processor, the computer program 610 executes the logistics information detection method provided in any of the foregoing implementations.

It should be noted that the computer-readable storage medium may also include, but not limited to, a phase-change random access memory (PRAM), a static random access memory (SRAM), a dynamic random access memory (DRAM), other types of random access memories (RAM), a read-only memory (ROM), an electrically erasable programmable read-only memory (EEPROM), a flash memory, or other optical or magnetic storage media, which are not enumerated here one by one.

The computer-readable storage medium provided in the above embodiments of the present application is based on the same inventive concept as that of the logistics information detection method provided in the embodiments of the present application, and has the same beneficial effects as those of the method adopted, performed, or implemented by an application program stored therein.

In addition, FIG. 6 shows only one embodiment of the computer-readable storage medium, not all embodiments. Based on the embodiment of the computer-readable storage medium in the present application, all other embodiments obtained by those skilled in the art without creative efforts shall fall within the protection scope of the present application.

The above only describes preferred specific implementations of the present application, but the protection scope of the present application is not limited thereto. Any changes or substitutions that can be easily conceived by those skilled in the art within the technical scope disclosed in the present application shall be covered within the protection scope of the present application. Therefore, the protection scope of the present application shall be subject to the protection scope of the claims.

What is claimed is:

1. A logistics information detection method, applied in a logistics information detection system, comprising:
receiving at least one set of transit information of a target parcel, wherein any set of transit information comprises a radiographic image, weighing data, and order information of the target parcel at a transit node;
determining, based on at least one of the weighing data and the order information in the at least one set of transit information and the radiographic image, a target transit node corresponding to the target parcel entering a preset lost state, wherein the preset lost state is used to represent a state in which the target parcel is lost;
outputting order information of the target transit node and information of the target transit node.

2. The method according to claim 1, wherein the determining, based on at least one of the weighing data and the order information in the at least one set of transit information and the radiographic image, the target transit node corresponding to the target parcel entering the preset lost state comprises:
for any set of transit information, detecting, based on the order information and the radiographic image in the transit information, whether the transit information represents that the target parcel is in the preset lost state;
in a case that the transit information represents that the target parcel is in the preset lost state, determining the transit node corresponding to the transit information as the target transit node.

3. The method according to claim 2, wherein the detecting, based on the order information and the radiographic image in the transit information, whether the transit information represents that the target parcel is in the preset lost state comprises:
determining an item state of the target parcel according to the radiographic image in the transit information, wherein the item state is used to represent whether an item is present in the target parcel and whether the target parcel is fully filled with the item if the item is present;
in a case that it is determined that no item is present in the target parcel, determining whether an item type indicated by the order information in the transit information is a preset type, so as to determine whether the transit information represents that the target parcel is in the preset lost state, wherein in a case that the item type indicated by the order information is the preset type, the transit information represents that the target parcel is in the preset lost state.

4. The method according to claim 3, wherein the determining the item state of the target parcel according to the radiographic image in the transit information comprises:
extracting a color feature of the radiographic image, wherein the color feature comprises a brightness feature value of the radiographic image, and the brightness feature value is used to represent a brightness value of the radiographic image;
determining the item state of the target parcel according to a magnitude relationship between the brightness feature value and a preset brightness threshold, wherein in a case that the brightness feature value is greater than the preset brightness threshold, no item is present in the target parcel.

5. The method according to claim 1, wherein in a case that the at least one set of transit information comprises at least two sets of transit information, the determining, based on at least one of the weighing data and the order information in the at least one set of transit information and the radiographic image, the target transit node corresponding to the target parcel entering the preset lost state comprises:
for any set of transit information, detecting, based on the order information and the radiographic image in the transit information, whether the target parcel is changed to be in the preset lost state;
in a case that the target parcel is changed to be in the preset lost state, determining the transit node corresponding to the transit information after a state change of the target parcel as the target transit node.

6. The method according to claim 5, wherein the detecting, based on the order information and the radiographic image in the transit information, whether the target parcel is changed to be in the preset lost state comprises:
determining an item state of the target parcel according to the radiographic image in the transit information, wherein the item state is used to represent whether an item is present in the target parcel and whether the target parcel is fully filled with the item if the item is present;
in a case that it is determined that no item is present in the target parcel, determining whether an item type indicated by the order information in the transit information is a preset type, so as to determine whether the target parcel is changed to be in the preset lost state.

7. The method according to claim 6, wherein the determining whether the item type indicated by the order information in the transit information is the preset type, so as to determine whether the target parcel is changed to be in the preset lost state comprises:
in a case that the item type indicated by the order information is not the preset type, starting from the transit information, sequentially comparing the weighing data in every two adjacent sets of transit information among the transit information acquired earlier than the transit information, wherein in the weighing data of every two adjacent sets of transit information, the weighing data in the transit information acquired later in time is first weighing data, and the weighing data in the transit information acquired earlier in time is second weighing data;
determining whether the target parcel is changed to be in the preset lost state according to the first weighing data and the second weighing data, wherein in a case that a first weight indicated by the first weighing data is less than a second weight indicated by the second weighing data, the target parcel is changed to be in the preset lost state at the transit node corresponding to the transit information acquired later in time, and the transit node corresponding to the transit information acquired later in time is the transit node corresponding to the transit information after a state change of the target parcel.

8. The method according to claim 1, wherein in a case that the at least one set of transit information comprises at least two sets of transit information, the determining, based on at least one of the weighing data and the order information in the at least one set of transit information and the radiographic image, a target transit node corresponding to the target parcel entering a preset lost state comprises:
detecting, based on the weighing data and the radiographic images in the at least two sets of transit information, whether the target parcel is changed to be in the preset lost state;
in a case that the target parcel is changed to be in the preset lost state, determining the transit node corresponding to the transit information after a state change of the target parcel as the target transit node.

9. The method according to claim 8, wherein the detecting, based on the weighing data and the radiographic images in the at least two sets of transit information, whether the target parcel is changed to be in the preset lost state comprises:
comparing i-th weighing data with (i-1)-th weighing data, wherein the i-th weighing data is the weighing data in i-th set of transit information among the at least two sets of transit information, the (i-1)-th weighing data is the weighing data in an (i-1)-th set of transit information among the at least two sets of transit information, and the i is an integer greater than or equal to 2;
in a case that an i-th weight indicated by the i-th weighing data is less than an (i-1)-th weight indicated by the (i-1)-th weighing data, detecting whether an i-th radiographic image is the same as the (i-1)-th radiographic image, wherein the i-th radiographic image is a radiographic image in the i-th set of transit information, and the (i-1)-th radiographic image is a radiographic image in the (i-1)-th set of transit information;
in a case that the i-th radiographic image is different from the (i-1)-th radiographic image, determining that the target parcel is changed to be in the preset lost state at the transit node corresponding to the i-th set of transit information, wherein the transit node corresponding to the transit information after a state change of the target parcel is the transit node corresponding to the i-th set of transit information.

10. The method according to claim 9, wherein the detecting whether an i-th radiographic image is the same as an (i-1)-th radiographic image comprises:
respectively extracting a semantic feature of the i-th radiographic image and a semantic feature of the (i-1)-th radiographic image to obtain a first semantic feature and a second semantic feature;
calculating a similarity parameter between the first semantic feature and the second semantic feature, wherein the similarity parameter is used to represent similarity between the first semantic feature and the second semantic feature;
determining whether the i-th radiographic image is the same as the (i-1)-th radiographic image according to the similarity represented by the similarity parameter and a preset similarity condition, wherein in a case that the similarity represented by the similarity parameter does not satisfy the preset similarity condition, the i-th radiographic image is different from the (i-1)-th radiographic image.

11. The method according to claim 8, wherein the detecting, based on the weighing data and the radiographic images in the at least two sets of transit information, whether the target parcel is changed to be in the preset lost state comprises:
for any set of transit information, determining an item state of the target parcel according to the radiographic image in the transit information, wherein the item state is used to represent whether an item is present in the target parcel and whether the target parcel is fully filled with the item if the item is present;
in a case that it is determined that no item is present in the target parcel and an item type indicated by the order information in the transit information is not a preset type, starting from the transit information, sequentially comparing the weighing data in every two adjacent sets of transit information among the transit information acquired earlier than the transit information, wherein in the weighing data of every two adjacent sets of transit information, the weighing data in the transit information acquired later in time is first weighing data, and the weighing data in the transit information acquired earlier in time is second weighing data;
determining whether the target parcel is changed to be in the preset lost state according to the first weighing data and the second weighing data, wherein in a case that a first weight indicated by the first weighing data is less than a second weight indicated by the second weighing data, the target parcel is changed to be in the preset lost state at the transit node corresponding to the transit information acquired later in time, and the transit node corresponding to the transit information acquired later in time is the transit node corresponding to the transit information after a state change of the target parcel.

12. The method according to claim 1, wherein the detection system comprises a first detection device, wherein the receiving at least one set of transit information of the target parcel comprises:
receiving, by the first detection device, a radiographic image and order information in the at least one set of transit information of the target parcel.

13. The method according to claim 12, wherein the determining, based on at least one of the weighing data and the order information in the at least one set of transit information and the radiographic image, the target transit node corresponding to the target parcel entering the preset lost state comprises:
in response to receiving the radiographic image and the order information in the at least one set of transit information, detecting, by the first detection device and based on the order information and the radiographic image in the at least one set of transit information, whether the at least one set of transit information represents that the target parcel is in the preset lost state.

14. The method according to claim 1, wherein the detection system comprises a first detection device and a second detection device, wherein the receiving at least one set of transit information of the target parcel comprises:
in a case that the first detection device receives at least two sets of transit information of the target parcel, receiving, by the second detection device, radiographic images, weighing data, and order information in the at least two sets of transit information of the target parcel.

15. The method according to claim 14, wherein the determining, based on at least one of the weighing data and the order information in the at least one set of transit information and the radiographic image, the target transit node corresponding to the target parcel entering the preset lost state comprises:
detecting, by the second detection device and based on the weighing data and the radiographic images in the at least two sets of transit information, whether the target parcel is changed to be in the preset lost state.

16. A logistics information detection system, comprising: a memory, a processor, and a computer program stored in the memory and run in the processor, wherein the processor runs the computer program to:
receive at least one set of transit information of a target parcel, wherein any set of transit information comprises a radiographic image, weighing data, and order information of the target parcel at a transit node;
determine, based on at least one of the weighing data and the order information in the at least one set of transit information and the radiographic image, a target transit node corresponding to the target parcel entering a preset lost state, wherein the preset lost state is used to represent a state in which the target parcel is lost;
output order information of the target transit node and information of the target transit node.

17. The detection system according to claim 16, wherein when determining, based on at least one of the weighing data and the order information in the at least one set of transit information and the radiographic image, the target transit node corresponding to the target parcel entering the preset lost state, the processor is specifically configured to:
for any set of transit information, detect, based on the order information and the radiographic image in the transit information, whether the transit information represents that the target parcel is in the preset lost state;
in a case that the transit information represents that the target parcel is in the preset lost state, determine the transit node corresponding to the transit information as the target transit node.

18. The detection system according to claim 17, wherein when detecting, based on the order information and the radiographic image in the transit information, whether the transit information represents that the target parcel is in the preset lost state, the processor is specifically configured to:
determine an item state of the target parcel according to the radiographic image in the transit information, wherein the item state is used to represent whether an item is present in the target parcel and whether the target parcel is fully filled with the item if the item is present;
in a case that it is determined that no item is present in the target parcel, determine whether an item type indicated by the order information in the transit information is a preset type, so as to determine whether the transit information represents that the target parcel is in the preset lost state, wherein in a case that the item type indicated by the order information is the preset type, the transit information represents that the target parcel is in the preset lost state.

19. The detection system according to claim 18, wherein when determining the item state of the target parcel according to the radiographic image in the transit information, the processor is specifically configured to:
extract a color feature of the radiographic image, wherein the color feature comprises a brightness feature value of the radiographic image, and the brightness feature value is used to represent a brightness value of the radiographic image;
determine the item state of the target parcel according to a magnitude relationship between the brightness feature value and a preset brightness threshold, wherein in a case that the brightness feature value is greater than the preset brightness threshold, no item is present in the target parcel.

20. A non-transitory computer-readable storage medium, having a computer program stored therein, wherein the computer program is executed by a processor to implement:
receiving at least one set of transit information of a target parcel, wherein any set of transit information comprises a radiographic image, weighing data, and order information of the target parcel at a transit node;
determining, based on at least one of the weighing data and the order information in the at least one set of transit information and the radiographic image, a target transit node corresponding to the target parcel entering a preset lost state, wherein the preset lost state is used to represent a state in which the target parcel is lost;
outputting order information of the target transit node and information of the target transit node.
